(19) United States
(12) Patent Application Publication
(10) Pub. No.: US 2026/0070625 A1
(43) Pub. Date: Mar. 12, 2026

(54) Motorcycle

(71) Applicant: Zhejiang CFMOTO Power Co., Ltd., Hangzhou (CN)

(72) Inventors: Shiwei Chen, Hangzhou (CN); Silin Wang, Hangzhou (CN); Jizhi Pan, Hangzhou (CN); Tongmin Xu, Hangzhou (CN); Yaofeng Wang, Hangzhou (CN); Junhu Zhu, Hangzhou (CN); Shunyu Lei, Hangzhou (CN); Chengqun Ma, Hangzhou (CN); Yong Su, Hangzhou (CN)

(21) Appl. No.: 19/388,733

(22) Filed: Nov. 13, 2025

Related U.S. Application Data
(63) Continuation of application No. PCT/CN2023/122287, filed on Sep. 27, 2023.

(30) Foreign Application Priority Data
May 19, 2023 (CN) 202310576395.9
Aug. 16, 2023 (CN) 202311034485.1

(51) Int. Cl. B62K 11/04; B62J 1/12; B62J 17/00; B62K 19/06; B62K 19/12

(52) U.S. Cl. CPC B62K 11/04; B62J 1/12; B62J 17/00; B62K 19/06; B62K 19/12

(57) ABSTRACT

A motorcycle has a main frame with main frame tubes formed of a first material such as 30CrMo steel tubing. A sub-frame with sub-frame tubes of the first material extends longitudinally and is detachably connected behind the main frame. A middle frame with vertically-extending legs provided by castings is behind the main frame, cast of a second material such as from ZGD410-700 stainless steel. A tailframe is detachably connected behind the sub-frame, the tailframe having tailframe plates of a third material, such as being cast from aluminum or an aluminum alloy. A thickness of the tailframe plates is in the transverse direction. A bottom support is substantially arranged below the main frame, detachably connected to the main frame and to the middle frame. Connection fittings formed of a fourth material such as forged 30CrMo steel can be used for the detachable connections of the tubes.

### RELATED APPLICATION INFORMATION

This is a continuation of Patent App. No. PCT/CN2023/122287, entitled “Motorcycle” and filed Sep. 27, 2023, and claims the benefits of priority to Chinese Patent Application No. 202310576395.9, entitled “Motorcycle”, filed with the Chinese Patent Office on May 19, 2023, and Chinese Patent Application No. 202311034485.1, entitled “Motorcycle”, filed with the Chinese Patent Office on Aug. 16, 2023. The entire contents of the above-referenced applications are incorporated herein by reference.

### FIELD OF THE DISCLOSURE

The disclosure relates to the field of vehicles, and particularly to a motorcycle.

### BACKGROUND OF THE DISCLOSURE

Motorcycles are two-(or sometimes three-) wheeled vehicles driven by an internal combustion engine or electric motor and operated by handlebars to turn the front wheel. Motorcycles are lightweight, flexible, and can travel quickly. They are widely used for transportation of persons and freight, and are also used as sports equipment. In general, motorcycles are divided into street bikes, road racing motorcycles, off-road motorcycles, cruise bikes, and touring motorcycles. Particularly for cruise motorcycles, compared to race motorcycles and off-road motorcycles, cruise motorcycles are equipped with front mounted foot pedals, thereby allowing the driver to maintain a straight and comfortable posture while riding.

The style of cruise motorcycle is quite unique, and their plastic parts have a smaller coverage area compared to other vehicles, which limits the wrapping of electrical systems and other parts. Therefore, it is an urgent problem in the field of cruise motorcycle research and manufacturing to make cruise motorcycles which have a compact internal space while maintaining superiority of their driver body positioning and their appearance.

### SUMMARY OF THE INVENTION

The present embodiment provides a motorcycle to solve at least one problem existing in the background.

The present invention involves a motorcycle having a frame, a prime mover assembly, a plurality of wheels, a vehicle cover and a suspension system. The frame includes a main frame and a sub-frame and a middle frame both positioned behind the main frame. The main frame has a plurality of main frame tubes extending longitudinally. The sub-frame also extends longitudinally. The middle frame has at least one vertically-extending leg. The prime mover assembly is at least partially supported by the main frame. The plurality of wheels includes a front wheel arranged at the front of the motorcycle and a rear wheel arranged at the rear of the motorcycle. The vehicle cover at least partially covers the frame. The suspension system includes a rear suspension assembly, with the rear wheel connected to the middle frame by the rear suspension assembly.

In a first aspect, the frame further includes a tailframe positioned behind the sub-frame. The main frame tubes are made of a first material, the vertically-extending leg of the middle frame is made of a second material, and a majority of the tailframe is made of a third material. The first material has a higher elongation at break than the second material and third material. The third material has a lower density than the first material and second material.

In another aspect, the tailframe comprises at least one tailframe plate. The tailframe plate is in the shape of an arc with its center substantially aligned with a rotation center of the rear wheel. The tailframe plate is formed of the third material, which is aluminum or an aluminum alloy.

The another aspect, the sub-frame has a plurality of sub-frame tubes extending longitudinally, and the sub-frame is detachably connected behind the main frame. The sub-frame tubes are also made of the first material. The first material of the main frame tubes and sub-frame tubes is steel. The frame further includes a bottom support positioned at least partially below the main frame, the bottom support being detachably connected to the main frame and detachably connected to the middle frame. The bottom support includes at least one bottom support tube formed of steel. The tailframe is detachably connected behind the sub-frame. The tailframe includes at least one tailframe plate which is formed of the third material, and the third material is aluminum or an aluminum alloy. The tailframe plate extends substantially vertically and longitudinally such that a thickness direction of the tailframe plate is in a transverse direction.

The details of one or more embodiments of the invention are presented in the drawings and description to make other features, objectives, and advantages of the present invention more concise and understandable.

### BRIEF DESCRIPTION OF THE DRAWINGS

The Drawings and their Descriptions Presented Herein are Intended to Explain and Provide Further Understanding of the Present Invention, but do not Constitute Undue Limitation of the Present Invention. In the Figures:

FIG. 1 is a rear left perspective view of a preferred motorcycle in accordance with the present invention;

FIG. 2 is a side view of a frame of the motorcycle of FIG. 1;

FIG. 3 is a rear left perspective view of most of the frame of FIG. 2, omitting the left tailplate;

FIG. 4 is an enlargement of section 4 of FIG. 3;

FIG. 5 is an enlargement of section 5 of FIG. 3;

FIG. 6 is a rear right perspective view of much of the bottom support of the frame and the foot pedal arrangement of the motorcycle of FIG. 1;

FIG. 7 is a rear left perspective view of the frame of FIG. 2;

FIG. 8 is an enlargement of section 8 of FIG. 7;

FIG. 9 is a front left perspective view of the frame of FIG. 2, and showing the rear mudguard assembly of the motorcycle of FIG. 1 in exploded view;

FIG. 10 is a side view of the frame, wheels, suspension assemblies and saddle assembly of the motorcycle of FIG. 1;

FIG. 11 is an enlargement of section 11 of FIG. 10;

FIG. 12 is a rear right perspective view of the frame, wheels, suspension assemblies and portions of the vehicle cover of the motorcycle of FIG. 1, and also showing the main seat, fuel tank and its mounting structure in exploded view;

FIG. 13 is an enlargement of section 13 of FIG. 12;

FIG. 14 is an enlargement of section 14 of FIG. 12;

FIG. 15 is an enlargement of section 15 of FIG. 12;

FIG. 16 is a rear right perspective view of the majority of the frame of FIG. 2, also showing portions of the radiator assembly, and showing portions of the vehicle cover of the motorcycle of FIG. 1 in exploded view;

FIG. 17 is a rear left perspective view of the structures shown in FIG. 16, with only the left side guard in exploded view;

FIG. 18 is a rear left perspective view of the frame and vehicle cover portions of FIG. 17, also showing the front wheel, front suspension and front turn signals of the motorcycle of FIG. 1;

FIG. 19 is an enlargement of section 19 of FIG. 18;

FIG. 20 is a rear view of the top bridge of the front suspension assembly of the motorcycle of FIG. 1;

FIG. 21 is a left side view of the top bridge of FIG. 20;

FIG. 22 is a rear perspective view of a portion of the frame of the motorcycle of claim 1, further showing the steering lock;

FIG. 23 is an enlargement of section 23 of FIG. 22;

FIG. 24 is a rear view of the frame portion and steering lock of FIG. 22, further showing a portion of the front suspension;

FIG. 25A is a top view of a lower bridge of the motorcycle when the steering assembly is directed straight forward;

FIG. 25B is a top view of the lower bridge of the motorcycle when the steering assembly is in a right turn;

FIG. 25C is a top view of a lower bridge of the motorcycle when the steering assembly is locked in a left turn;

FIG. 26 is a rear left perspective view of a frame portion and portions of the vehicle cover of the motorcycle of FIG. 1, further showing the radiator assembly;

FIG. 27 is an exploded view of the structures shown in FIG. 26;

FIG. 28 is a rear right exploded perspective view of the left taillight of the motorcycle of FIG. 1; and

FIG. 29 is a cross-sectional top plan view of the taillight of FIG. 19.

### DETAILED DESCRIPTION

The present invention will be described in detail with reference to the specific embodiments shown in the accompanying drawings, but these embodiments do not limit the present invention. Any structural, methodological, or functional changes made by those skilled in the art based on these embodiments are included within the scope of protection of the present invention.

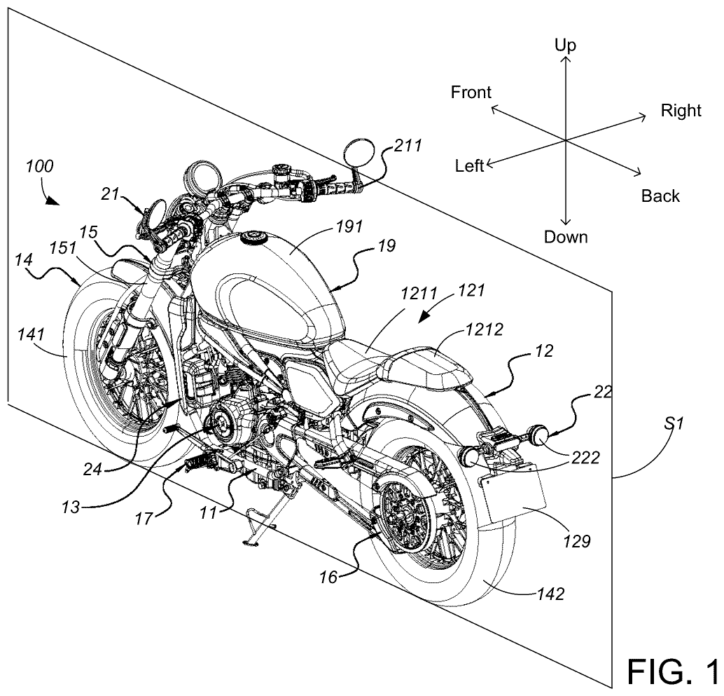

As shown in FIG. 1, the invention involves a motorcycle 100 which includes a frame 11, a vehicle cover 12, a prime mover assembly 13 and a plurality of wheels 14. The prime mover assembly 13 is at least partially mounted on the frame 11 and supported by the frame 11. The vehicle cover 12 is at least partially arranged on the frame 11, and the vehicle cover 12 at least partially covers the prime mover assembly 13 for protecting the prime mover assembly 13. The plurality of wheels 14 includes a front wheel 141 arranged at the front of the motorcycle 100 and a rear wheel 142 arranged at the rear of the motorcycle 100. Furthermore, the motorcycle 100 also includes a front suspension assembly 15 connecting the front wheel 141 to the frame 11 and a rear suspension assembly 16 connecting the rear wheel 142 to the frame 11. The directions of front, back, left, right, up, and down are shown in FIG. 1. The front-back direction refers to the length or longitudinal direction of motorcycle 100, the left-right direction refers to the width, transverse, lateral or cross direction of motorcycle 100, and the up-down direction refers to the height or vertical direction of motorcycle 100, when the motorcycle 100 is upright relative to a longitudinal midplane S1.

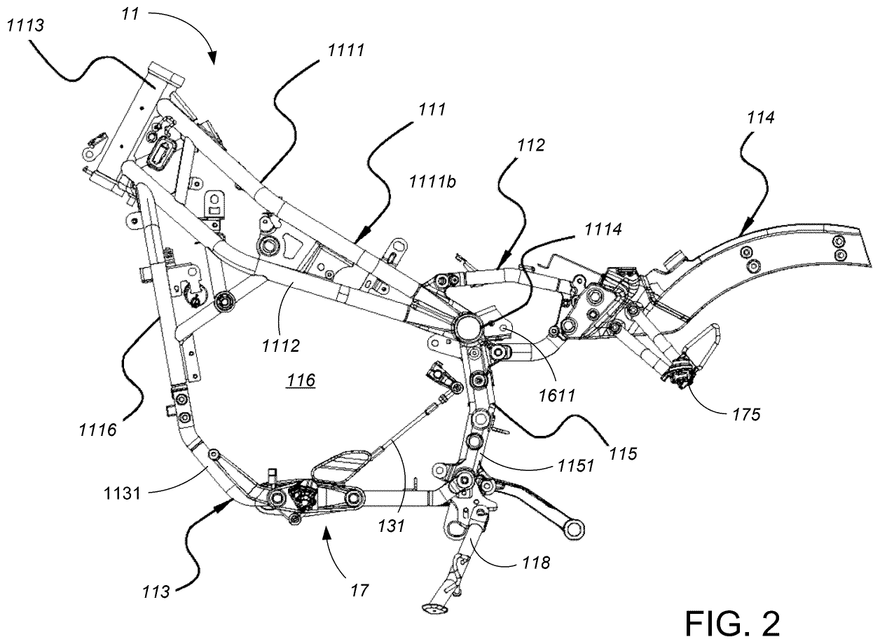

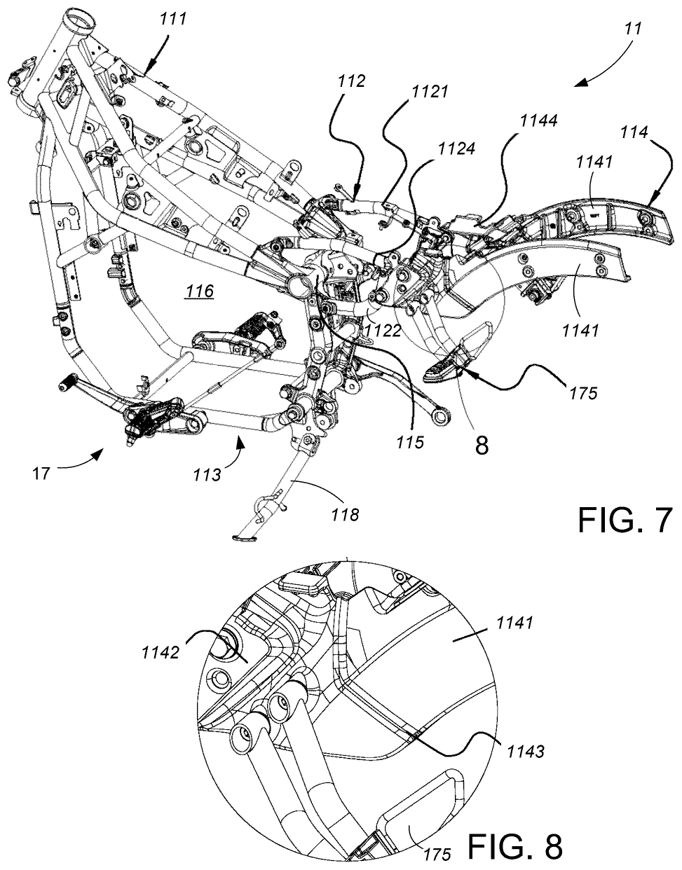

As shown in FIGS. 2, 3 and 7, the frame 11 includes a main frame 111, a sub-frame 112, a bottom support 113, a tailframe 114 and a middle frame 115. The sub-frame 112 is detachably connected to the main frame 111 and extends rearwardly from the rear end of the main frame 111. The middle frame 115 is connected to the main frame 111 and extends downwardly from the rear end of the main frame 111. The bottom support 113 is at least partially arranged below the main frame 111 so as to generally support the bottom of the prime mover assembly 13, detachably connected to the main frame 111 and to the lower end of the middle frame 115. The tailframe 114 is detachably connected to a rear end of the sub-frame 112, running longitudinally rearwardly therefrom. A receiving space 116, called out in FIGS. 2 and 7, is defined between the bottom support 113 and the main frame 111 and in front of the middle frame 115, and the prime mover assembly 13 (shown in FIG. 1) is at least partially received within the receiving space 116.

The main frame 111 shares portions of its design with the main frame disclosed in U.S. patent application Ser. No. 18/752,026, incorporated by reference. Specifically, the main frame 111 includes right and left upper frame tubes 1111 extending longitudinally and right and left lower frame tubes 1112 running longitudinally substantially under the respective upper frame tubes 1111. The main frame 111 includes a head tube 1113 fixed at the front ends of the upper and lower frame tubes 1111, 1112, and two castings 1114 joined by a main crosstube 1115 and fixed at the rear ends of the upper and lower frame tubes 1111, 1112.

The upper and lower frame tubes 1111, 1112 are made from tubing of a first strong and rigid material, preferably metal and more preferably alloy steel. Preferably, the first material has a tensile strength of about 522-638 MPa, a yield strength of about 468-572 MPa, and an elongation at break of about 16%-19.8%. Most preferably, the upper and lower frame tubes 1111, 1112 are made from tubing of 20CrMo steel. 20CrMo steel is an alloy structural steel known for its high hardenability, good weldability, and excellent wear resistance after heat treatment. 20CrMo steel tubing has a tensile strength of about 580 MPa, a yield strength of about 520 MPa, and an elongation at break of about 18%. If desired, the head tube 1113 and the main crosstube 1115 may also be formed from tubing of the first material.

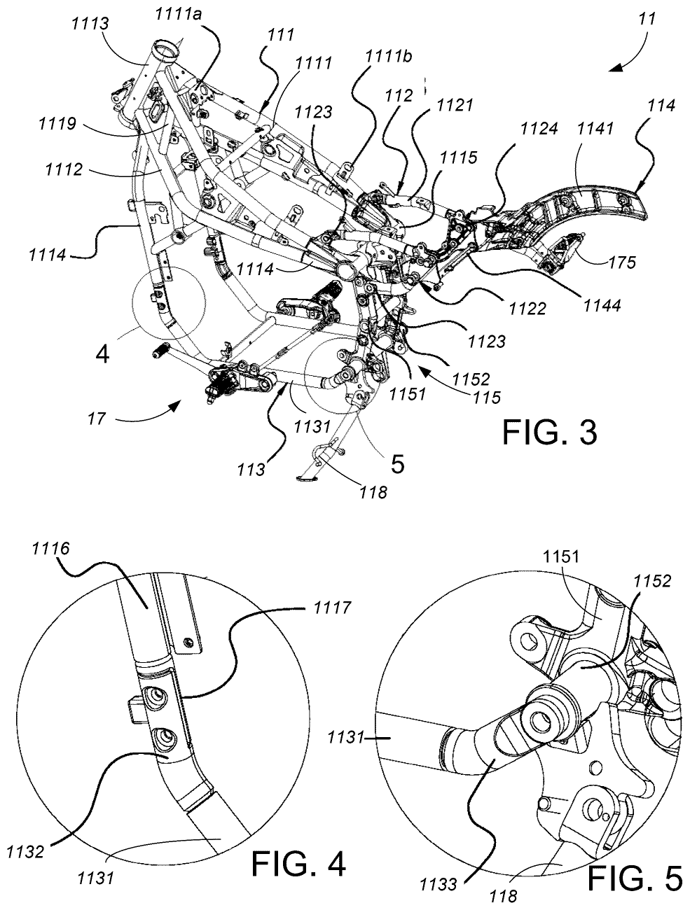

Called out in FIGS. 2 and 3, the castings 1114 preferably integrally provide both the rear end of the main frame 111 and respective right and left vertically extending legs 1151 of the middle frame 115. The castings 1114 carry the weight of the driver relative to the rear suspension assembly 16 (shown in FIGS. 1, 10 and 12), requiring high strength and compression resistance. The castings 1114 are cast of a second material so as to have one or more different material properties than the first material, specifically a higher tensile strength, a higher yield strength, and a lower elongation at break. Preferably, the second material has a tensile strength of 630-770 MPa, a yield strength of 369-451 MPa, and an elongation at break of 14.4-16%. The castings 1114 are preferably metal and more preferably casting grade stainless steel. Most preferably, the castings 1114 are cast from a specific variant of 410 stainless steel such as ZGD410-700, cast to have a tensile strength of 700 MPa, a yield strength of 410 MPa, and an elongation at break of 16%.

The sub-frame 112 shares portions of its design with the subframe disclosed in U.S. patent application Ser. No. 18/752,026, incorporated by reference. Specifically and as called out in FIGS. 3 and 7, the sub-frame 112 includes right and left upper sub-frame tubes 1121 and right and left lower sub-frame tubes 1122. However, the sub-frame tubes 1121, 1122, though still substantially symmetrical with respect to the longitudinal midplane S1, and each shorter and shaped somewhat differently than the subframe tubes of U.S. patent application Ser. No. 18/752,026. The sub-frame tubes 1121, 1122 are each preferably formed from tubing of the first material.

The tailframe 114 is detachably connected to the rear end of the sub-frame 112. The preferred tailframe 114 includes right and left tailframe plates 1141 as main components (i.e., making up a majority of the tailframe 114) that each extend substantially vertically and longitudinally parallel to the longitudinal midplane S1, such that a thickness direction of the tailframe plates 1141 is in the transverse direction. The tailframe plates 1141 are formed out of a third material so as to have one or more different material properties than the first material and one or more different material properties than the second material. Specifically, the third material has a lower density than either the first material or the second material. The tailframe plates 1141 are subjected to less bending stresses than the frame tubes 1111, 1112 and sub-frame tubes 1121, 1122, so high values for tensile strength, yield strength and elongation at break are not as important. The third material is preferably a metal with a density lower than steel, and more preferably aluminum or an aluminum-based alloy, and most preferably ZL101A cast aluminum alloy. ZL101A is an alloy composed primarily of aluminum and silicon, with additions of magnesium, iron and copper, known for good fluidity and low shrinkage and therefore making it suitable for casting complex and relatively thin-walled shapes. ZL101A has a density of 2.68-2.69 g/cm³, as compared to a density of about 7.85 g/cm³ for 20CrMo steel and a density of about 7.64-7.75 g/cm³ for ZGD410-700 stainless steel. ZL101A has a tensile strength of about 115-300 MPa, a yield strength of 23-240 MPa, and an elongation at break of about 2-8%, all depending upon heat treatment. Forming tailframe plates 1141 of the third material ensures a sufficiently high overall strength of the tailframe 114 while reducing weight.

Unlike the main frame disclosed in U.S. patent application Ser. No. 18/752,026, the preferred main frame 111 also includes right and left descending tubes 1116, which are preferably welded to front ends of the respective lower frame tubes 1112 just behind the head tube 1113 and extend downwardly and slightly rearwardly from their connection to the respective lower frame tube 1112. The bottom support 113 is also unlike the frame disclosed in U.S. patent application Ser. No. 18/752,026, and includes right and left bottom support tubes 1131.

The connection junction between the bottom support tubes 1131 and the descending tubes 1116 preferably involves fittings formed of a fourth material. Specifically and as best shown in FIG. 4, bottom ends of the descending tubes 1116 include bottom connection fittings 1117 which are preferably welded to the descending tubes 1116, and front ends of the bottom support tubes 1131 include front connection fittings 1132 which are preferably welded to the bottom support tubes 1131. The bottom and front connection fittings 1117, 1132 are formed out of a fourth material so as to have one or more different material properties than the first material, one or more different material properties than the second material and one or more different material properties than the third material. Preferably, the second material has a tensile strength of about 796-973 MPa, a yield strength of about 616-753 MPa, and an elongation at break of about 11-13%. The bottom and front connection fittings 1117, 1132 are preferably formed of metal, more preferably formed of alloy steel, and most preferably formed by forging of 20CrMo steel. The 20CrMo steel forgings have tensile strength of about 885 MPa, a yield strength of about 685 MPa, and an elongation at break of about 12%. Forming the connection fittings 1117, 1132 out of the same composition (but forged rather than tubing) steel as the descending tubes 1116 and the bottom support tubes 1131 helps for a stronger welded connection between the fittings 1117, 1132 and the respective tubes 1116, 1131 with better corrosion resistance than welding two different compositions.

The connection junction between the bottom support tubes 1131 and the midframe 115 preferably also involves fittings formed of the fourth material. Specifically and as best shown in FIG. 5, rear ends of the bottom support tubes 1131 include rear connection fittings 1133 welded thereto. Like the front connection fittings 1132, the rear connection fittings 1133 are most preferably 20CrMo steel forgings.

The sub-frame 112 preferably also uses connection fittings of the fourth material to attach the upper and lower sub-frame tubes 1121, 1122 to the castings 1114. Specifically as called out in FIG. 3, the upper and lower sub-frame tubes 1121, 1122 each have mid connection fittings 1123 welded to each of their four front ends. Like the other connection fittings 1117, 1132, 1133, the four mid connection fittings 1123 are all most preferably 20CrMo steel forgings.

In order to make assembly of the sub-frame 112 easier and more secure, the sub-frame 112 includes a tail connecting bracket 1124. The rear ends of the two upper sub-frame tubes 1121 and the rear ends of the two lower sub-frame tubes 1122 are fixed to the tail connecting bracket 1124, preferably by welding. Use of a tail connecting bracket 1124 to join all four sub-frame tubes 1121, 1122 enhances the stability of the sub-frame 112 and improves the overall strength of the frame 11.

The mid connection fittings 1123 are in surface contact with the castings 1114, connected by means of fasteners such as screws or bolts (not separately called out). The tailframe 114 is in surface contact with the tail connecting bracket 1124, connected by means of fasteners such as screws or bolts (not separately called out). The bottom connection fittings 1117 are in surface contact with the front connection fittings 1132, connected by means of fasteners such as screws or bolts (not separately called out). The rear connection fittings 1133 are in surface contact with right and left ends of a lower crosstube 1152 of the middle frame 115, connected by means of fasteners such as screws or bolts (not separately called out). The mounting direction of all these fasteners is substantially transverse, which helps reduce torsion across the fasteners when the motorcycle 100 is subjected to load.

The tailframe plates 1141 are each in the shape of an arc with its center substantially the same as the rotation center of the rear wheel 142. The lateral spacing between the tailframe plates 1141 is substantially the same as the width of the rear wheel 142.

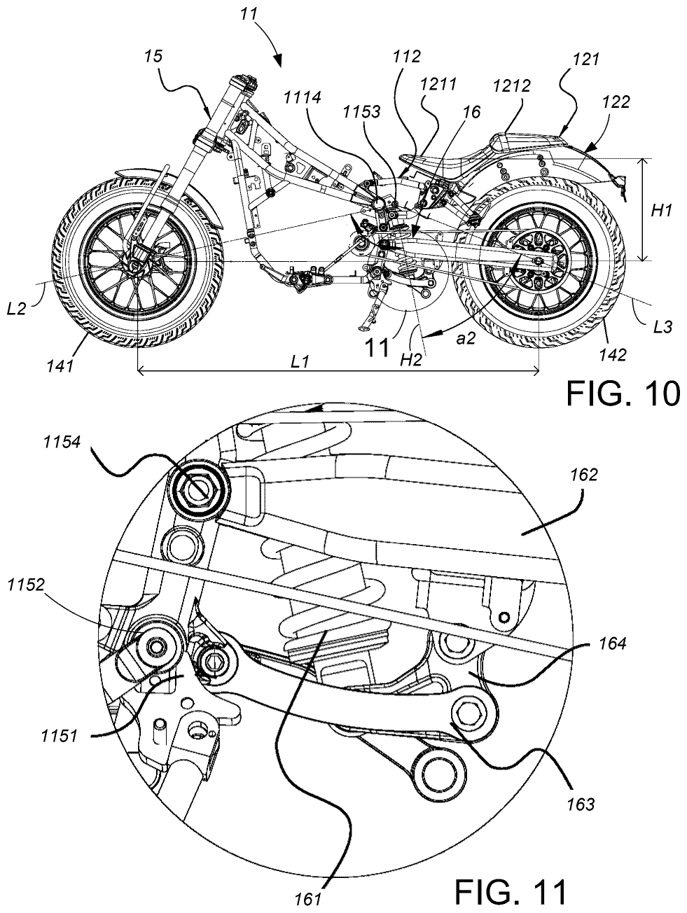

The vehicle cover 12 includes a saddle assembly 121 with a main seat 1211 as shown in FIGS. 1 and 10. The main seat 1211 is at least partially arranged on the main frame 111 or the sub-frame 112 for the driver to ride on. The saddle assembly 121 preferably further includes a secondary seat 1212. The secondary seat 1212 may be mounted on the sub-frame 112 and/or the tailframe 114 for the passengers to ride on.

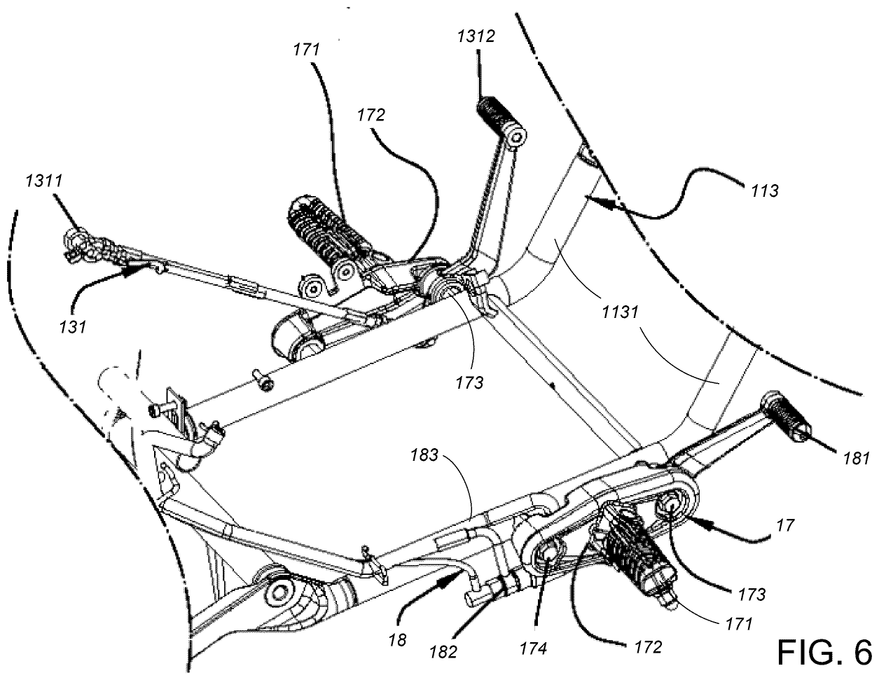

The motorcycle 100 includes a foot pedal arrangement 17 best shown in FIGS. 3, 6 and 7. The foot pedal arrangement 17 allows the driver to perform shifting and braking operations as well as providing a footrest for the driver's feet. In side view, the foot pedal arrangement 17 at least partially overlaps the prime mover assembly 13. As called out in FIG. 6, the foot pedal arrangement 17 includes a right and left foot pegs 171 each fixedly mounted on the outsides of the respective bottom support tube 1131 by a foot peg mount 172. Each foot peg mount 172 is fixedly connected to the respective bottom support tube 1131 through two or more longitudinally spaced mounting bolts 173, 174.

One of the driver's feet, preferably the driver's left foot, is used for shifting gears of the prime mover assembly 13. The prime mover assembly 13 includes a shifting assembly 131, which includes a transmission rod 1311 and a shift lever 1312. The transmission rod 1311 and the shift lever 1312 are at least partially positioned between the left foot peg mount 172 and the left bottom support tube 1131. The shift lever 1312 is pivotally mounted on the bottom support tube 1131 by a forward mounting bolt 173 of the left foot peg mount 172. A forward end of the transmission rod 1311 is connected to the shift lever 1312, and the other rearward end of the transmission rod 1311 is connected to the prime mover assembly 13. The driver can input commands to the prime mover assembly 13 through the transmission rod 1311 to perform shifting operations on the prime mover assembly 13. A portion (not shown) of the vehicle cover 12 can at least partially cover the transmission rod 1311 to protect it and prevent the driver's left foot from interfering with movement of the transmission rod 1311. In other embodiments, the shift lever may be pivotally connected to the bottom support tube 131 through the rear mounting bolt 174. Using one of the mounting bolts 173 for the dual purpose of mounting the left foot peg 171 and mounting the shift lever 1312 effectively reduces the number of mounting points into the bottom support tube 1131, making the structure simpler, easier to install, and effectively ensuring the structural strength of the bottom support 113.

One of the driver's feet, preferably the driver's right foot, is used for braking the motorcycle 100. The motorcycle 100 includes a brake system 18, which includes a foot brake lever 181 and a brake fluid pump 182. The foot brake lever 181 is pivotally mounted on the outside of the right bottom support tube 1131 by a forward mounting bolt 173 of the right foot peg mount 172. The brake system 18 further includes a brake (not shown) mounted on at least one of the wheels 14. One end of the brake fluid pump 182 is connected to the foot brake lever 181, and the other end of the brake fluid pump 182 is connected to the brake through a brake fluid pipeline 183. The driver can brake the motorcycle 100 at least in part through pressing on the foot brake lever 181. The brake fluid pump 182 is fixedly connected to the respective bottom support tube 1131 using the forward mounting bolt 173 and the rearward mounting bolt 174. Using the mounting bolts 173, 174 for the tri-purpose of mounting the right foot peg 171, mounting the foot brake lever 181 and mounting the brake fluid pump 182 effectively reduces the number of mounting points into the associated bottom support tube 1131, making the structure simpler, easier to install, and effectively ensuring the structural strength of the bottom support 113.

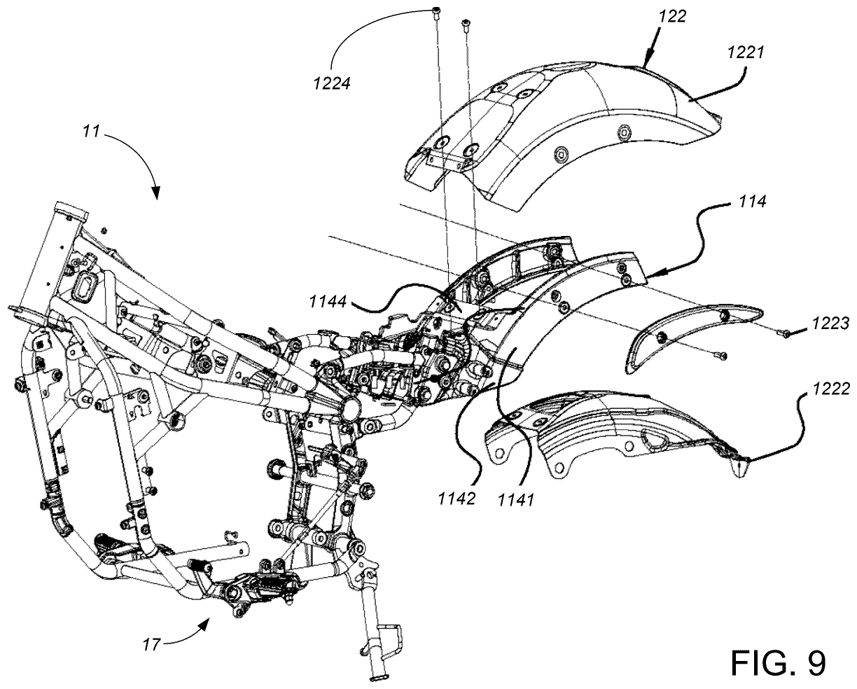

The vehicle cover 12 further includes a rear mudguard assembly 122 best shown in FIGS. 1 and 9. The rear mudguard assembly 122 is fixedly connected to the tailframe 114 to block water, mud and sand stirred up by the rear wheel 142 during running. The rear mudguard assembly 122 includes an upper mudguard cover 1221 and a lower mudguard 1222. Both the upper mudguard cover 1221 and the lower mudguard 1222 are formed of sheet material, preferably metal, and more preferably iron or steel sheet material. The lower mudguard 1222 is substantially positioned below the tailframe 114, closest to the tire of the rear wheel 142, so as to block most of the spray from the rear wheel 142. The upper mudguard cover 1221 is positioned over the tailframe 114 and at least partially covers the lower mudguard 1222, so as to provide a more pleasing aesthetic appearance to the motorcycle 100.

Both the lower mudguard 1222 and the upper mudguard cover 1221 span laterally across the tailframe plates 1141 and are fixedly connected to the tailframe 114 by fasteners such as screws or bolts, preferably including one or more horizontally-oriented mudguard fasteners 1223 and one or more vertically-oriented mudguard fasteners 1224. The tailframe 114 preferably includes one or more transverse tailframe connection straps 1144 running between the two tailframe plates 1141 as called out in FIG. 9. The transverse tailframe connection strap(s) 1144 help provide cross support between the two tailframe plates 1141 and also provide fixation points for attaching other components to the tailframe 114. The transverse tailframe connection strap(s) 1144 are not necessarily formed of the third material, but instead can be formed of sheet steel or plate steel. At least some of the horizontally-oriented mudguard fastener(s) 1223 are preferably received in the tailframe plates 1141, while at least some of the vertically-oriented mudguard fastener(s) 1224 are preferably received in the transverse tailframe connection strap(s) 1144. Other mudguard fasteners (not shown) may directly attach the lower mudguard 1222 and the upper mudguard cover 1221, sandwiching the lower mudguard 1222 and the upper mudguard cover 1221 around the tailframe plates 1141. Use of both horizontally-oriented mudguard fasteners 1223 and vertically-oriented mudguard fasteners 1224 allows the connection between the upper mudguard cover 1221 and the tailframe 114 and the connection between the lower mudguard 1222 and the tailframe 114 to be more stable and longer lasting.

As shown in FIGS. 1 and 10, the secondary seat 1212 is arranged on the rear mudguard assembly 122, preferably fixedly connected to the upper mudguard cover 1221 and/or to the transverse tailframe connection strap(s) 1144. The lower mudguard 1222 and/or the tailframe plates 1141 may further be used to arrange rear taillights 222 and license plate components 129 on the back of the motorcycle 100 as shown in FIG. 1.

As called out in FIGS. 7-9, each tailframe plate 1141 includes a fixing flange 1142 on its proximal end. Each tailframe plate 1141 is fixedly connected to the tail connecting bracket 1124 of the sub-frame 112 by the fixing flange 1142. The fixing flange 1142 is preferably an integral part of the casting of the tailframe plate 1141. In the preferred embodiment, an abutment shoulder 1143 is defined on the rear end of the fixing flange 1142. The height of the abutment shoulder 1143 is substantially the same as the thickness of the upper mudguard cover 1221, and the forward end of the upper mudguard cover 1221 abuts against the abutment shoulder 1143. This arrangement ensures that after the upper mudguard cover 1221 defines a smooth appearance with the fixing flange 1142. Compared to the existing rear mudguards, the rear mudguard assembly 122 of the present invention has greater structural strength provided by the tailframe 114 and more comprehensive wrapping, which can provide superior mudguarding performance.

When the secondary seat 1212 for passenger riding is mounted on the tailframe 114, the motorcycle 100 preferably further includes right and left auxiliary foot pegs 175 mounted to the tailframe 114 as shown in FIGS. 2, 3, 7 and 8. Preferably, the auxiliary foot pegs 175 are pivotally mounted to the fixing flange 1142 of the tailframe 114.

The preferred rear suspension assembly 16 is substantially as disclosed in U.S. patent application Ser. No. 18/752,026, incorporated by reference. Specifically and as best shown in FIGS. 10 and 11, the rear suspension assembly 16 includes a rear shock absorber 161 extending downwardly from an upper shock absorber mount 1153 (mounted such as with a bolt), rocker arms 162, an intermediate crosstube 1154 on the middle frame 115, and a linkage including right and left substantially horizontal links 163 and a triangular central substantially vertical link 164, all operating as disclosed in U.S. patent application Ser. No. 18/752,026.

The motorcycle 100 in the preferred embodiment is considered a “cruiser”, and FIG. 10 shows several of the dimensional relationships characteristic of this type of motorcycle 100. The preferred motorcycle 100 has a relatively large wheelbase L1, measured between the rotational axes of the two wheels 141, 142. Specifically, the preferred wheelbase L1 is greater than or equal to 1470 mm and less than or equal to 1500 mm. The seat height H1 of the motorcycle 100, defined as a vertical distance between a saddle point of the main seat 1211 and a line connecting the rotational axes of the two wheels 14, is arranged correspondingly on the premise of setting the foot pedal mounts 172 on the bottom support tubes 1131. In order to conform to the extended and reclined sitting posture of a cruiser, a seat height ratio H1/L1 of the seat height H1 to the wheelbase L1 of the motorcycle 100 is greater than or equal to 0.22 and less than or equal to 0.26.

As further shown in FIG. 10, the rear shock absorber 161 extends along a rear shock centerline H2. A middle frame front line L2 is defined to run between the rotation center of the front wheel 141 and the center of the upper shock absorber mount/bolt 1153, and a middle frame rear line L3 is defined to run between the rotation center of the rear wheel 142 and the center of the upper shock absorber mount/bolt 1153. A middle frame front angle α1 is defined between the rear shock centerline H2 and the middle frame front line L2, and a middle frame rear angle α2 is defined between the rear shock centerline H2 and the middle frame rear line L3. A rear shock angle ratio α1/α2 between the middle frame front angle α1 and the middle frame rear angle α2 is preferably greater than or equal to 4 and less than or equal to 5. A rear shock angle ratio α1/α2 in the preferred range makes the layout of the rear suspension assembly 16 more compact on the entire vehicle 100 and reduce the exposure of the rear shock absorber 161 to improve appearance. Avoiding the use of traditional dual rear shock absorbers also effectively reduces the width of motorcycle 100, unusual for a cruiser type extended wheelbase L1.

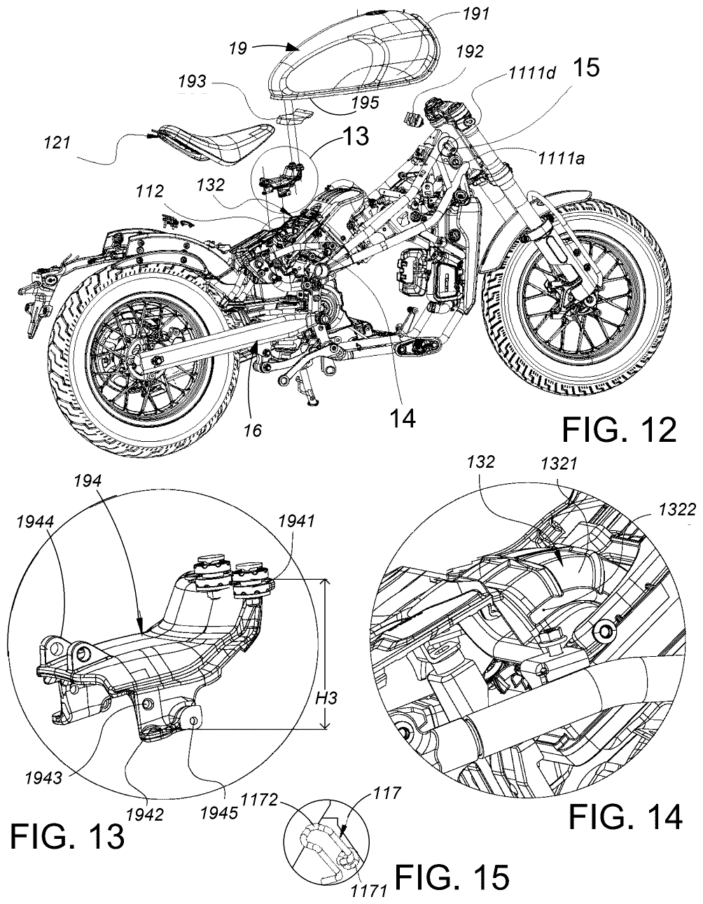

The motorcycle 100 further includes a fuel system 19, portions of which are described with reference to FIGS. 12 and 13. The fuel system 19 includes a fuel tank 191 for accommodating fuel, preferably mounted high in the motorcycle 100 such as over the main frame 111. More specifically, the fuel tank 191 is mounted using at least a front tank stop 192 positioned at the front end of the fuel tank 191 and a rear tank connection bracket 193 positioned at the rear end of the fuel tank 191. The fuel tank 191 abuts against the main frame 111 against the front tank stop 192, and is fixedly connected to the sub-frame 112 by the rear tank connection bracket 193. Without removing portions of the vehicle cover 12, the front tank stop 192 and the rear tank connection bracket 193 cannot be directly observed.

As called out in FIGS. 2 and 3, the frame 11 includes a front tank mount connection plate 1111a arranged between the upper frame tubes 1111 adjacent to and just behind the head tube 1113. Right and left ends of the front tank mount connection plate 1111a are fixedly connected to the right and left upper frame tubes 1111, respectively, such as by welding and such that the front tank mount connection plate 1111a is aligned in the width direction of the motorcycle 100. The front tank stop 192 is preferably detachably fixed relative to the frame 11, such as by bolting the front tank stop 192 to the front tank mount connection plate 1111a.

Right and left rear tank mount connection flanges 1111b for fixedly connecting the fuel tank 191 are fixedly connected to or integrally formed with the upper frame tubes 1111 as called out in FIGS. 2 and 3. As shown in FIGS. 12, 13 and 16, a tank adapter 194 is used for fixing the rear tank connection bracket 193 relative to the sub-frame 112, so as to support and affix the fuel tank 191 at a fixing location further rearward than the rear tank mount connection flanges 1111b. The tank adapter 194 is preferably bolted upwardly to the rear tank connection bracket 193 and bolted downwardly to the upper sub-frame tubes 1121. The tank adapter 194 helps reduce shaking of the fuel tank 191 in the width direction relative to the frame 11, thereby making the mounting of the fuel tank 191 more stable. The tank adapter 194 includes one or more tank contact points 1941 for connection against the fuel tank 191 and/or for connection against the rear tank connection bracket 193, and one or more subframe contact points 1942 for connection against the sub-frame 112 such as against the upper sub-frame tubes 1121. The subframe contact point(s) 1942 is/are positioned substantially below the tank contact point(s) 1941, separated by an adapter height distance H3. The adapter height distance H3 between the tank contact point(s) 1941 and the subframe contact point(s) 1942 is preferably greater than or equal to 80 mm and less than or equal to 100 mm.

The prime mover assembly 13 includes an air filter assembly 132 called out in FIGS. 12 and 14. As air filter receiving chamber 195 is formed on the underside of the fuel tank 191 facing the prime mover assembly 13. The air filter assembly 132 is at least partially received within the air filter receiving chamber 195 of the fuel tank 191, at least partially disposed below the tank adapter 194. The adapter height distance H3 between the tank contact point 1941 and the subframe contact point 1942 allows the relative position of the fuel tank 191 to be shifted upwardly, thereby creating a larger accommodating space below the fuel tank 191 and between the tank adapter 194 and the sub-frame 112, thereby facilitating placement of the air filter assembly 132 on the motorcycle 100.

The air filter assembly 132 preferably includes an intake duct 1321 generally positioned below the tank adapter 194 which opens towards the rear of the motorcycle 100. The tank adapter 194 further defines an intake duct connection recess 1943 used for connection with an intake duct protrusion 1322 of the intake duct 1321. The intake duct connection recess 1943 may be a through hole or groove in the left-right direction. At least a portion of the intake duct protrusion 1322 is inserted in the intake duct connection recess 1943, so that the intake duct 1321 forms a stable connection with the tank adapter 194, thereby minimizing shaking of the intake duct 1321 during riding. The shape of the tank adapter 194 creates a large accommodating space between the saddle assembly 121 and the frame 11 allowing easier placement of the air filter assembly 132.

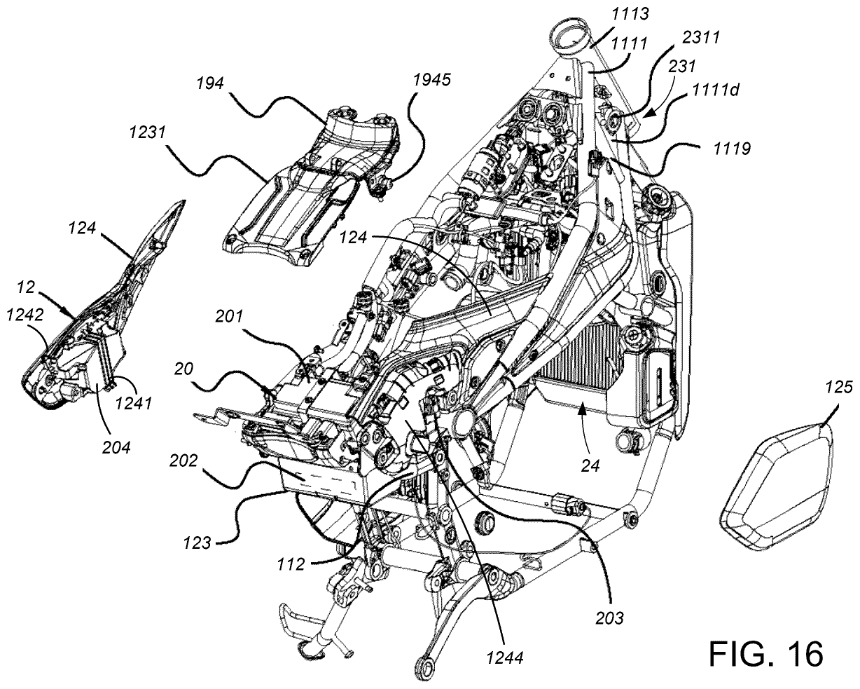

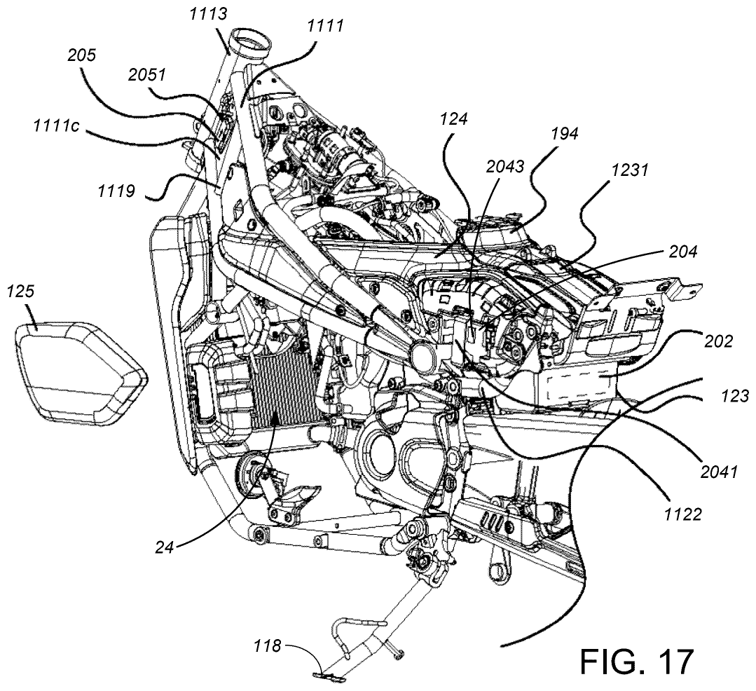

The tank adapter 194 further defines at least one, and more preferably right and left saddle connection flanges 1944, as well as at least one, and more preferably right and left cover connection flanges 1945. The saddle connection flange(s) 1944 is (are) positioned toward a top of the tank adapter 194, and the saddle assembly 121 is fixedly connected to the tank adapter 194 through the saddle connection flange(s) 1944, such as by bolting. The cover connection flanges 1945 are preferably positioned toward right and left sides of the tank adapter 194, and other portions of the vehicle cover 12 such as right and left side guards 124 (shown in FIGS. 16 and 17) are fixedly and detachably connected to the tank adapter 194 through the cover connection flange(s) 1945, such as by bolting. The side guards 124 are preferably positioned outside the sub-frame 112 to cover and protect at least a top portion of the prime mover assembly 13 inside the motorcycle 100. The tank adapter 194 is a metal part such as formed of steel, which facilitates the tank adapter 194 to have sufficient strength to bear the weight of the fuel tank 191 and the weight transmitted from the saddle assembly 121.

The motorcycle 100 includes an electrical system 20, portions of which are shown in FIG. 16. Specifically, the electrical system 20 includes a battery 201 for providing low-voltage power to the motorcycle 100 and an electronic controller 202 such as a vehicle control unit (“VCU”). Preferably, both the battery 201 and the electronic controller 202 are arranged below the saddle assembly 121, at least partially in an accommodating space formed between the saddle assembly 121 and the frame 11. The battery 201 and the electronic controller 202 are further at least partially arranged within the sub-frame 112. In the preferred embodiment, the electronic controller 202 is positioned below the battery 201, making it easier to disassemble by removing the battery 201 and perform insitu maintenance on the electronic controller 202. Only the saddle assembly 121 needs to be disassembled to gain access to battery 201 and the electronic controller 202, which is convenient for later maintenance of the motorcycle 100. Alternatively, the electronic controller 202 can be placed on the left, right, front, or rear side of the battery 201, still within the sub-frame 112 and beneath the saddle assembly 121.

The vehicle cover 12 preferably includes an internal cover 123 as shown in FIG. 16 forming a receiving space below the saddle assembly 121 for accommodating and covering the electronic controller 202 and the battery 201. The internal cover 123 is fixedly connected to the sub-frame 112. The internal cover 123 includes a detachable lid 1231 positioned at the rear end of the tank adapter 194 and above the battery 201 and electronic controller 202. The internal cover 123 including its lid 1231 forms a substantially closed chamber for protecting the electronic controller 202 and the battery 201.

The preferred side guards 124 are adapted to better receive and support portions of the electrical system 20. Specifically, the electrical system 20 further includes a relay 203 called out in FIG. 16 and a processor 204 called out in FIGS. 16 and 17. As a preferred embodiment, the processor 204 is a T-BOX (Telematics BOX Remote Information Processor) fixed to the side guard 124 such as by a strap 1241. The left side guard 124 preferably includes a processor mounting portion 1242 and a processor maintenance port 1243 such as an OBD (On Board Diagnostics) interface port so a plug-in electrical connection can be made with the processor 204. The right side guard 124 preferably includes a relay mounting portion 1244. Other embodiments mount the relay 203 and the processor 204 in mirrored positions. A clip on port guard 125 is detachably connected to each side guard 124, which is removable by hand without the use of any tools. In side view, the clip on port guards 125 overlap with the relay 203 and the processor 204. The clip on port guards 125 allow access to the processor maintenance port 1243 and inspection of the relay 203 and the processor 204 without requiring any tools, and further allow replacement of the relay 203 and the processor 204 without disassembling the side guards 124. The preferred right and left clip on port guards 125 have mirror image exterior shapes and are substantially symmetrical relative to the longitudinal midplane S1, improving the aesthetics of the motorcycle 100.

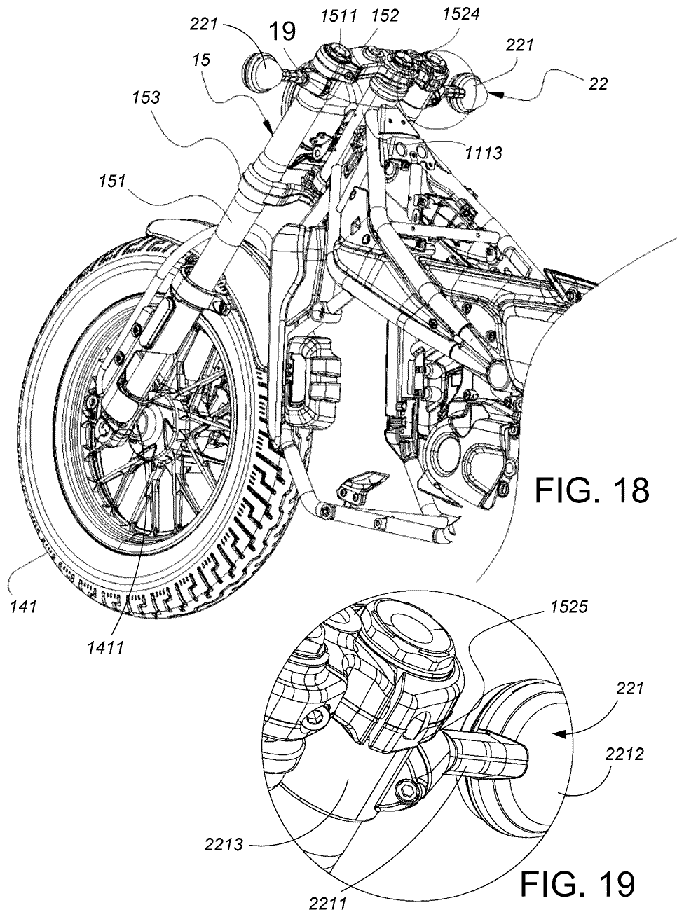

The front suspension assembly 15 includes two front shock absorbers 151 arranged on right and left sides of the front wheel 141 as shown in FIG. 1, and additional aspects of the front suspension assembly 15 are called out in FIG. 18. The front wheel 141 is rotatably connected to the front shock absorbers 151 through a front axle 1411. The front suspension assembly 15 further includes a top bridge 152 positioned at the tops of the front shock absorbers 151 and a lower bridge 153 positioned below the top bridge 152. The head tube 1113 extends between the top bridge 152 and the lower bridge 153, with the top bridge 152 and the lower bridge 153 both rotatably connected to head tube 1113. The motorcycle 100 further includes a steering assembly 21 with a handlebar 211 (both as shown in FIG. 1) fixedly mounted on the top bridge 152. The handlebar 211 drives the top bridge 152 to rotate relative to the head tube 1113, with the top bridge 152 causing the lower bridge 153 and the front shock absorbers 151 to rotate relative to the head tube 1113, thereby controlling steering of the motorcycle 100.

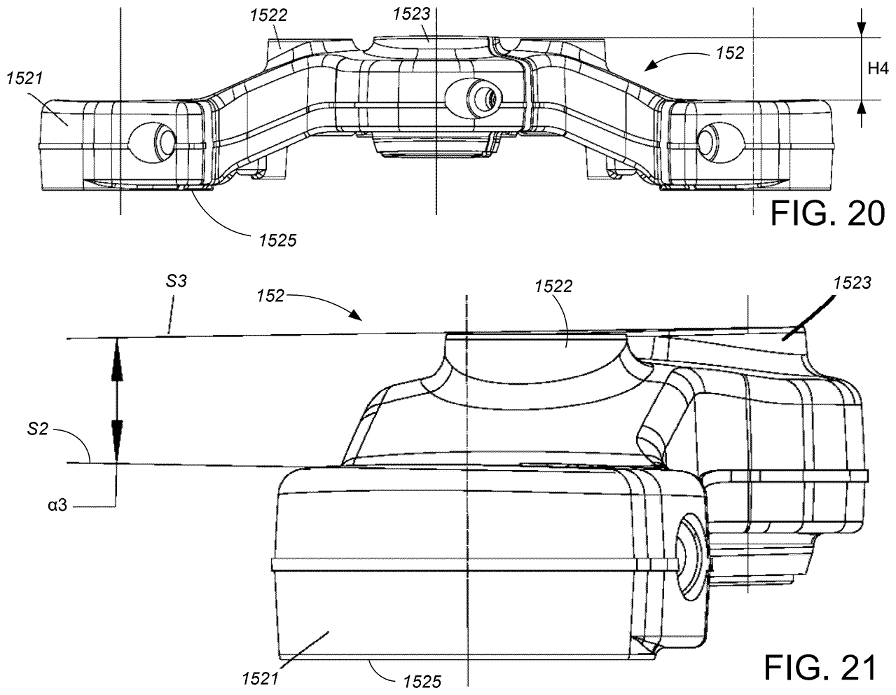

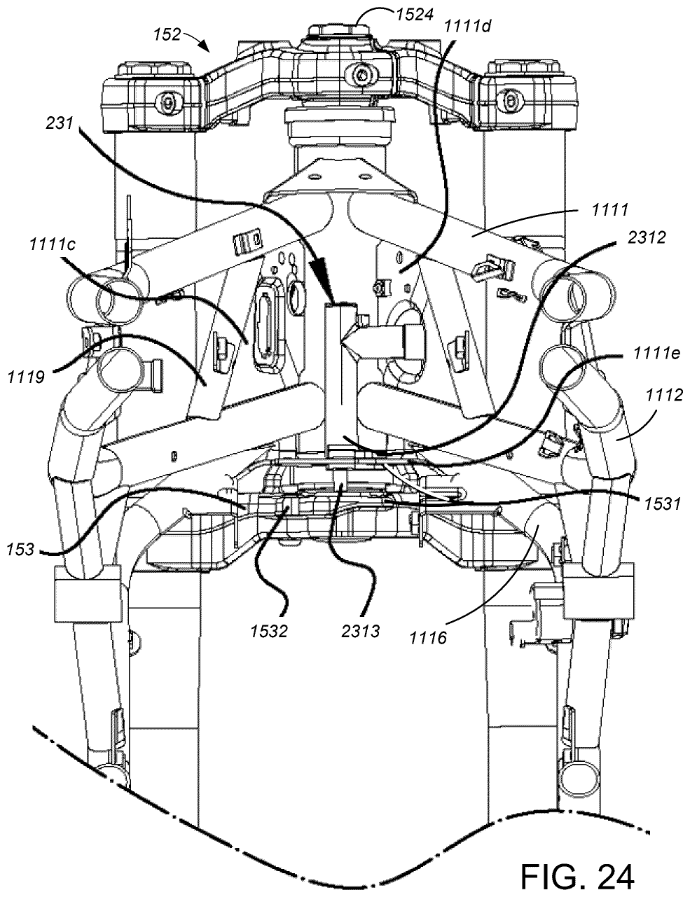

The preferred top bridge 152 is shown in rear and side views in FIGS. 20 and 21. The top bridge 152 includes right and left shock absorber mounting portions 1521 for connecting the front shock absorbers 151 (preferably in an interference fit), a handlebar mounting portion 1522 for connecting the handlebar 211 (preferably by welding), and a head tube mounting portion 1523 for rotatably connecting to the head tube 1113. The upper end of each front shock absorber 151 is further provided with an upper cover 1511 called out in FIG. 18, such that each front shock absorber 151 is fixedly connected to the top bridge 152 by the upper cover 1511. A main bolt 1524 (called out in FIGS. 18 and 24) extends coaxially through at least part of the head tube 1113 to rotatably connect the top bridge 152 to the head tube 1113.

As called out in FIG. 21, a top surface of the shock absorber mounting portion 1521 extends along a front shock absorber mounting plane S2, and a top surface of the head tube mounting portion 1523 extends along the head tube mounting plane S3. The front shock absorber mounting plane S2 is substantially perpendicular to the extension axes of the front shock absorbers 151, and the head tube mounting plane S3 is substantially perpendicular to the rotation axis of the top bridge 152 relative to the head tube 1113. The top bridge 152 is preferably substantially arch-shaped, that is, the shock absorber mounting portions 1521 are preferably positioned at least partially below the head tube mounting portion 1523, with a top bridge height H4 defined between the shock absorber mounting portions 1521 and the head tube mounting portion 1523. The top bridge height H4 between the shock absorber mounting portions 1521 and the head tube mounting portion 1523 is preferably greater than 0 and less than or equal to 60 mm, more preferably greater than 0 and less than or equal to 30 mm, and most preferably greater than or equal to 20 mm and less than or equal to 25 mm. Due to the top bridge height H4, the length of the front shock absorber 151 from the top bridge 152 to the front wheel axle 1411 is shortened, effectively reducing the shock-absorbing stroke of the front shock absorbers 151 while also ensuring the strength of the top bridge 152 of the steering assembly 21 during turning, and also reducing weight and effectively lowering costs.

In side view, the front shock absorbers 151 extend forward of the head tube 1113. That is, when not turning, the axes of the front shock absorbers 151 are positioned further forward than the axis of the head tube 1113. The more forwardly spaced the front shock absorbers 151 are from the head tube 1113, the longer the top bridge 152 and the lower bridge 153 must be in the length direction of the motorcycle 100, and the farther the front shock absorbers 151 are spaced from the head tube 1113. Greater spacing between the front shock absorbers 151 and the head tube 1113 leads to greater loads carried by the top bridge 152 and lower bridge 153. In the preferred embodiment, a top bridge angle α3 is defined between the front shock absorber mounting plane S2 and the head tube mounting plane S3. The top bridge angle α3 is preferably greater than or equal to 1 degree and less than or equal to 3 degrees, and more preferably greater than or equal to 1.2 degrees and less than or equal to 1.9 degrees. A positive value for the top bridge angle α3 increases the extension of the front wheel 141 (appropriate for a cruiser) while making the layout between the head tube 1113 and the front shock absorber 151 more compact, avoiding difficulty of turning and effectively improving maneuverability of the motorcycle 100 via the steering assembly 21.

The motorcycle 100 includes a lighting system 22, a portion of which is shown in FIGS. 18 and 19. The lighting system 22 includes right and left front turn signals 221 arranged in the front of the motorcycle 100. The front turn signals 221 are preferably fixedly connected to the front shock absorbers 151 just below the top bridge 152. Each front turn signal 221 includes a front signal connecting rod 2211, a front signal lamp body 2212 positioned at a distal end of the front signal connecting rod 2211, and a front signal mounting ring 2213 positioned at a proximal end of the front signal connecting rod 2211. The front signal mounting ring 2213 at least partially surrounds the outer circumference of the respective front shock absorber 151, preferably secured with an interference fit to the front shock absorber 151. The top bridge 152 preferably includes an abutment portion 1525 on its bottom surface which further restricts movement of the front signal mounting ring 2213 relative to the front shock absorber 151.

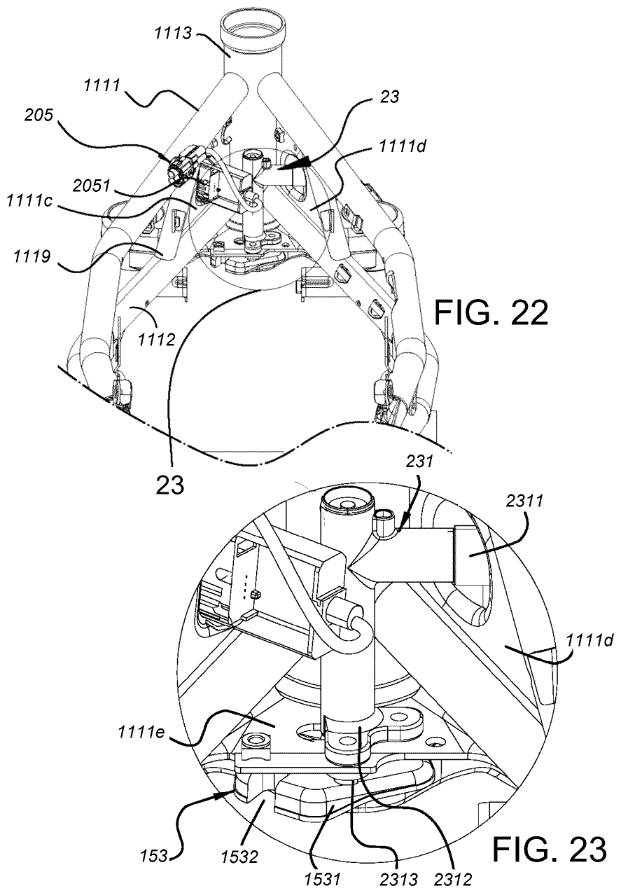

The preferred main frame 111 includes right and left struts 1119 fixedly connected between the respective upper and lower frame tubes 1111, 1112. As called out in FIGS. 22-24, the main frame 111 further includes a left head mounting plate 1111c and a right head mounting plate 1111d fixedly connected to the head tube 1113, the respective upper frame tubes 1111, and the respective struts 1119.

The electrical system 20 further includes an electrical connection port 205 defined on the left head mounting plate 1111c, which is preferably a Universal Serial Bus (USB) interface. The USB port 205 is electrically connected to the battery 201 and can be used to charge and/or communicate with the driver's mobile (smartphone) terminal, thereby effectively improving the driving experience. An elastic USB port cover 2051 is preferably provided outside the left head mounting plate 1111c to protect the exposed USB port 205 to prevent foreign objects or rainwater from entering and contaminating the USB port 205. The USB port 205 is preferably electrically connected to the battery 201 through the relay 203, so the USB port 205 cannot draw current when the prime mover assembly 13 is not running, helping to avoid inadvertent draining of the battery 201.

The right head mounting plate 1111d is provided with a wire hook 117 best shown in FIG. 15. The wire hook 117 includes a proximal fixing base 1171 supporting a distally-extending hooking length 1172. The fixing base 1171 and the hooking length 1172 are preferably integrally formed by bending a strip of metal. The wire hook 117 is detachably connected to the right head mounting plate 1111d such as with a bolt-through connection. The hooking length 1172 extends away from the right head mounting plate 1111d and can be used for carrying and guiding wiring harnesses (not shown). Alternatively, the wire hook 117 could be detachably mounted on other areas of the motorcycle 100.

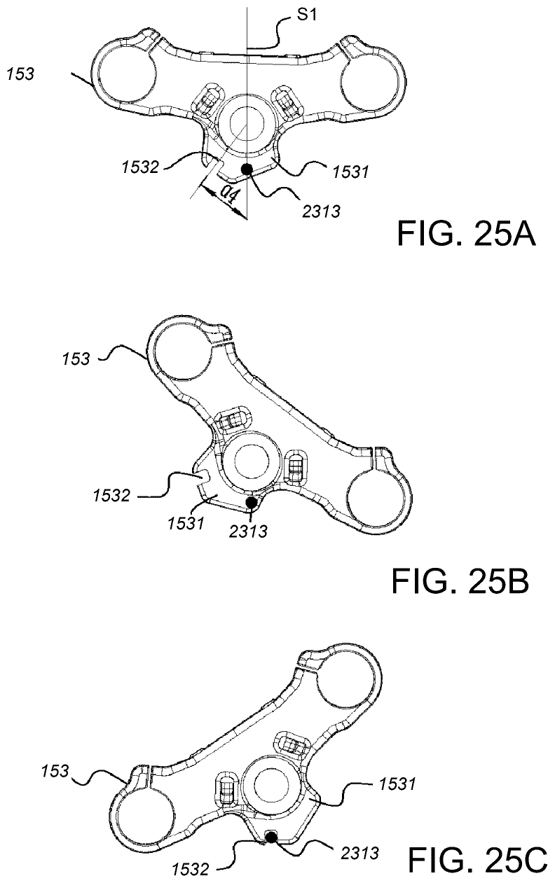

The motorcycle 100 preferably includes one or more locking devices 23, such as a steering lock 231 as shown in FIGS. 16, 22 and 23 for locking the steering assembly 21. The steering lock 231 is preferably at least partially mounted so as to extend through the right head mounting plate 1111d. A horizontal head mounting plate 1111e extends horizontally between and just below the lower frame tubes 1112, fixedly connected to the head tube 1113. Furthermore, a locking plate 1531 is fixed on the lower bridge 153, extending rearwardly behind the head tube 1113 and adjacent the horizontal head mounting plate 1111e. The steering lock 231 includes a keyhole portion 2311, an executing barrel 2312 and a locking tongue 2313. The driver can manipulate internal structures (not shown) of the executing barrel 1312 by using a key (not shown) in the keyhole portion 2311, causing the locking tongue 2313 to either engage or disengage with a locking recess 1532 on the locking plate 1531. When the steering lock 231 is in the unlocked state, the locking tongue 2313 is substantially positioned above the locking plate 1531, allowing the locking plate 1531 and therefore the lower bridge 153 to pivot relative to the horizontal head mounting plate 1111e for steering of the motorcycle 100. When a locking operation is required, the driver rotates the front suspension assembly 15 from the position of FIG. 25A or 25B until the locking tongue 2313 is aligned with and can be moved into the locking recess 1532 in the position of FIG. 25C. When the steering lock 231 is in the locked state, the locking tongue 2313 extends into the locking recess 1532, preventing the locking plate 1531 from pivoting relative to the horizontal head mounting plate 1111e and the rest of the frame 11. This steering lock 231 avoids drilling holes in the head tube 1113.

A locking angle α4 is defined based on how far off, when the front wheel 141 is aligned with the longitudinal midplane S1, the locking recess 1532 is offset from the longitudinal midplane S1. In the preferred embodiment with the kickstand on the left, the locking angle α4 is about 37° to the left. In one alternative embodiment, the locking angle α4 is greater than or equal to 2° to the left and less than or equal to 5° to the left. In other alternative embodiments, the locking angle α4 is to the right.

Preferably, a locking stroke of the steering lock 231 (i.e., the distance that the locking tongue 2313 moves from the unlocked state to the locked state) is greater than or equal to 6 mm and less than or equal to 10 mm. Preferably, the locking tongue 2313 in the unlocked state is at an elevation greater than or equal to 2 mm and less than or equal to 6 mm over the locking recess 1532. In the most preferred embodiment, the locking stroke of the steering lock 231 is 8 mm, and when the steering lock 231 is in the unlocked state, the locking tongue 2313 is 4 mm above the locking recess 1532. This arrangement prevents the locking tongue 2313 from accidentally falling into the locking recess 1532 in the unlocked state, while still providing effective locking strength of the steering assembly 21 in the locked state, thereby ensuring the anti-theft safety of motorcycle 100.

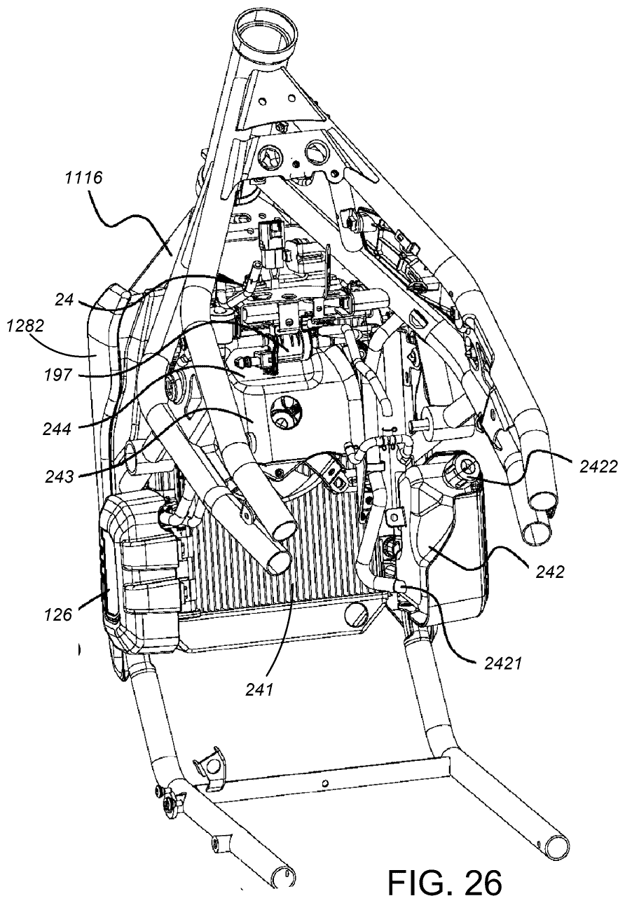

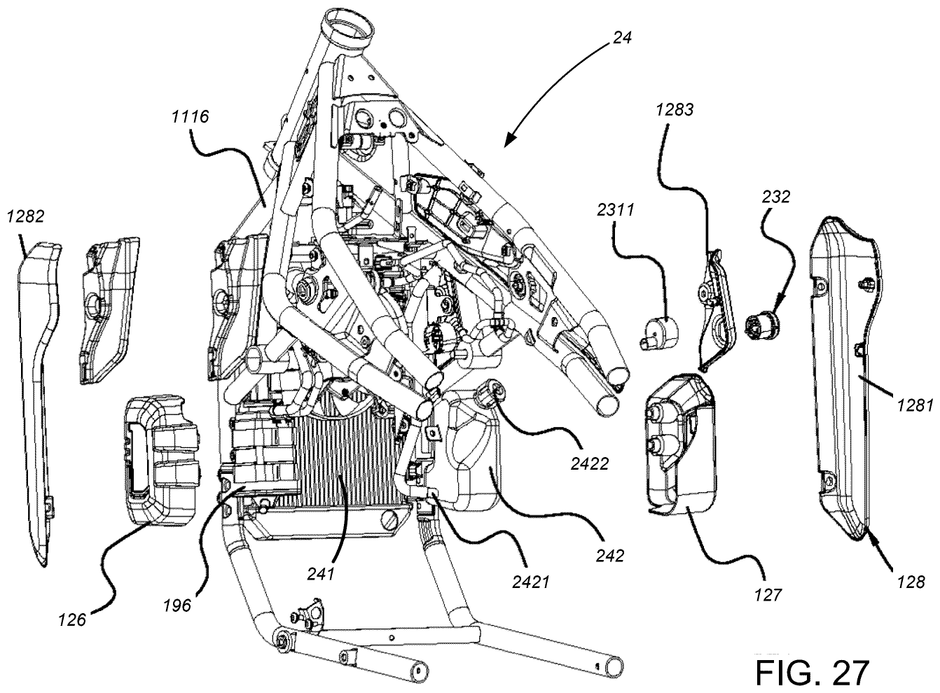

The motorcycle 100 further includes a radiator assembly 24, shown in FIGS. 16 and 17 and described in detail with reference to FIGS. 26 and 27. The radiator assembly 24 includes a radiator 241 arranged toward the front of the motorcycle 100, and an overflow tank 242 in fluid connection with the radiator 241 as known in the vehicle arts. The radiator 241 is filled with coolant (not shown) and the overflow tank 242 is partially filled with coolant. The radiator assembly 24 circulates coolant between the prime mover assembly 13 and the radiator 241 during running of the motorcycle 100, which is cooled in the radiator 241 by exterior air flow to pull heat from the prime mover assembly 13. When the motorcycle 100 is no longer being driven and the prime mover assembly 13 stops, coolant inside the radiator 241 and prime mover assembly 13 cools and reduces its volume, and the radiator 241 sucks in coolant from the overflow tank 242. Preferably both the radiator 241 and the overflow tank 242 are fixedly connected to the descending tubes 1116. A coolant supply pipeline 2421 is arranged to run substantially between the bottom of the overflow tank 242 and the radiator 241. The motorcycle 100 further includes a kickstand 118 as called out in FIGS. 2, 3, 7 and 17, and the coolant supply pipeline 2421 is preferably positioned on the same side of the overflow tank 242 as the kickstand 118 in on the motorcycle 100, in the preferred embodiment both on the left. This location ensures that coolant fills the coolant supply pipeline 2421 regardless of acceleration, deceleration and any slope on which the motorcycle 100 is parked, avoiding air suction which could adversely affect the heat dissipation performance of the radiator assembly 24.

In side view, the overflow tank 242 is at least partially arranged between the foot pedal arrangement 17 (such as shown in FIG. 6) and the radiator 241. This arrangement allows the overflow tank 242 to help block the driver's ankle adjacent the foot pedal arrangement 17 (particularly the driver's right ankle in the preferred embodiment) from hot air blown through the radiator 241.

The overflow tank 242 includes a fill cap 2422 positioned at the upper end of the overflow tank 242. Preferably, the fill cap 2422 points outwardly, e.g., when the overflow tank 242 is positioned on the right side of the motorcycle 100, the fill cap 2422 extends outwardly from the right side of the overflow tank 242. This location and orientation of the fill cap 2422 can facilitate access to the fill cap 2422 by maintenance personnel such as to inspect and possibly add coolant.

The fuel system 19 includes a carbon canister 196 (shown in FIG. 27) connected by a pipeline (not separately called out) to the fuel tank 191 (shown in FIGS. 1 and 12). As known in vehicle fuel system arts, activated carbon material inside the carbon canister 196 can adsorb fuel which evaporates inside the fuel tank 191. The carbon canister 196 is preferably at least partially mounted on and fixedly connected to the descending tubes 1116. In the preferred layout, the carbon canister 196 is arranged substantially symmetrically to the overflow tank 242 relative to the longitudinal midplane S1, i.e., in the preferred embodiment shown, the carbon canister 196 is positioned on the left side of the longitudinal midplane S1, and the overflow tank 242 is positioned at relatively the same height and longitudinal position as the carbon canister 196 but on the right side of motorcycle 100. The vehicle cover 12 includes a carbon canister guard 126 and an overflow tank guard 127. The carbon canister guard 126 is detachably connected to the frame 11 so as to cover the outside of the carbon canister 196, and the overflow tank guard 127 is detachably connected to the frame 11 so as to cover the outside of overflow tank 242. Alternative embodiments provide a mirror image layout for the carbon canister 196 and the overflow tank 242, or position both the carbon canister 196 and the overflow tank 242 at a different elevation or longitudinal position.

The fuel system 19 includes a solenoid valve 197 as called out in FIG. 26 which controls fluid communication between the carbon canister 196 and the fuel tank 191 and/or the prime mover assembly 13. The solenoid valve 197 is at least partially disposed above the radiator 241, and the radiator assembly 24 includes a heat shield 243 with an avoidance portion 244 recessed towards the interior of the radiator assembly 24. The solenoid valve 197 is preferably at least partially disposed within the avoidance portion 244 of the radiator assembly heat shield 243, which can effectively improve the compactness of the mounting layout in the motorcycle 100. Furthermore, the solenoid valve 197 extends across the longitudinal midplane S1, and is positioned substantially in front of the prime mover assembly 13. This arrangement makes the layout of the entire fuel vapor pipeline (not separately called out) more compact, and can use the radiator assembly 24 to shield and protect the solenoid valve 197 and beautify the vehicle appearance.

The vehicle cover 12 further includes a radiator guard portion 128 as called out in FIG. 27. The radiator guard portion 128 of the vehicle cover 12 preferably includes a right radiator sideguard 1281 and a left radiator sideguard 1282, which are preferably layed out so as to be substantially symmetrical relative to the longitudinal midplane S1. The radiator sideguards 1281, 1282 are detachably connected to the outer sides of the descending tubes 1116. This mounting arrangement can keep the weight of the radiator sideguards 1281, 1282 off the radiator assembly 24, thereby reducing the connection burden of the radiator assembly 24.

The motorcycle 100 includes a power lock 232 called out in FIG. 27, which in the preferred embodiment shares the keyhole portion 2311 with the steering lock 231. The right radiator sideguard 1281 is provided with a lock mounting portion 1283, and the power lock 232 is at least partially set on the right radiator sideguard 1281 and is detachably connected to the right radiator sideguard 1281, preferably by clamping the lock mounting portion 1282 to the right radiator sideguard 1281. The lock mounting portion 1283 may be detachably connected to the right radiator sideguard 1281 and/or detachably connected to the frame 11. Alternative embodiments form the lock mounting portion 1283 integrally with the right radiator sideguard 1281 rather than as separate parts.

The power lock 232 is electrically connected to both the battery 201 and the electronic controller 202, and can be used to turn on low-voltage power for the motorcycle 100 including for controlling start-up of the prime mover assembly 13 through the relay 203. The power lock 232 is preferably arranged for access through the right radiator sideguard 1281, making it more convenient for the driver to operate the lock and more in line with the operating habits of most users. Alternative embodiments position the power lock 232 on the left side of the vehicle 100.

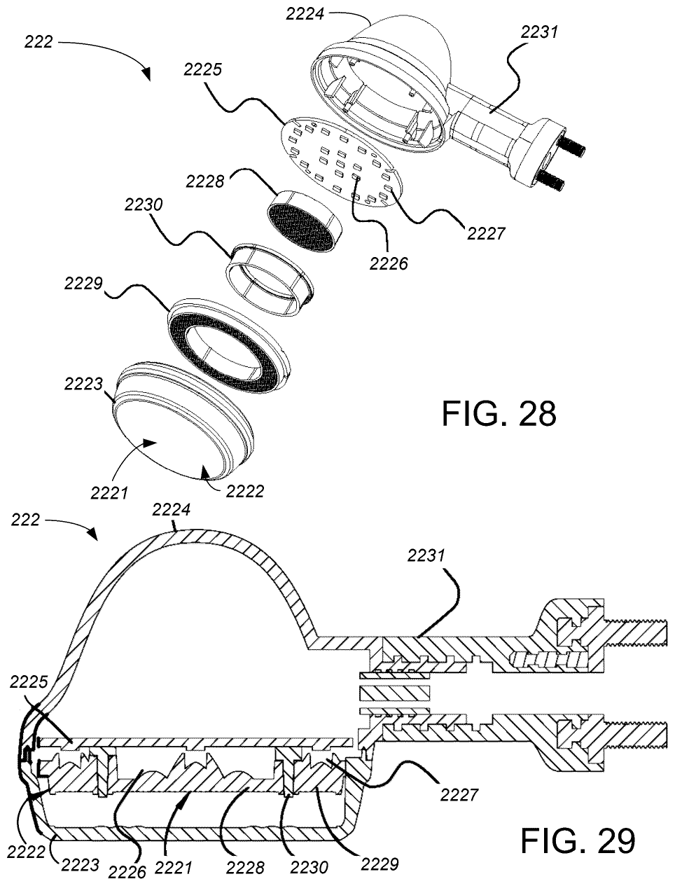

As shown in FIG. 1, the lighting system 22 further includes left and right rear-facing taillights 222 mounted at the rear of the motorcycle 100 and aligned with each other in the width direction of the motorcycle 100 substantially symmetrical relative to the longitudinal midplane S1. The left taillight 222 is better shown in FIGS. 28 and 29. Each taillight 222 includes two lighting areas: a first lighting area 2221 which preferably occupies a center location on the taillight 222 and an outer lighting area 2222 which preferably occupies an outer location on the taillight 222, encircling the center lighting area 2221. In the preferred embodiment, the center lighting area 2221 and the outer lighting area 2222 are both circular. Each lighting area 2221, 2222 is capable of emitting one or more distinct lighting signals through methods such as emitting light of different brightness, emitting light of different color, and emitting light in a flashing pattern. As a preferred implementation, the information content of the signal from the center lighting area 2221 provides running and brake light signals, while the information content of the signal from the outer lighting area 2222 provides turn and/or position signals. While the preferred shapes for lighting areas 2221, 2222 are intuitive and provide uniform signals, other embodiments use other shapes for the two lighting areas 2221, 2222, as long as the corresponding light signals can be achieved.

Each taillight 222 includes a lampshade 2223 and a lamp housing 2224, which cooperate to define a substantially closed space for accommodating electrical and light-emitting components. The preferred light-emitting components are light emitting diodes (“LEDs”), though other types of light-emitting components can alternatively be used. The taillight 222 thus includes a circuit board 2225 supporting a first, center grouping of rearwardly-facing LEDs 2226 and further supporting a second, outer grouping of rearwardly-facing LEDs 2227. The taillight 222 further includes a first, center lens 2228 and a second, outer lens 2229 positioned between the circuit board 2225 and the lampshade 2223. Each lens 2228, 2229 has a shape substantially consistent with the shape of the associated lighting area 2221, 2222. A light blocking plate 2230 is arranged between the center lens 2228 and the outer lens 2229, so as to avoid the phenomenon of stray light between the center lighting area 2221 and the outer lighting area 2222. The center grouping of LEDs 2226 and the center lens 2228 jointly achieve the optical signal output of the center lighting area 2221, and the outer grouping of LEDs 2227 and the outer lens 2229 jointly achieve the optical signal output of the outer lighting area 2222.

Each taillight 222 further includes a lamp mounting post 2231 for connecting with the motorcycle 100. One end of the lamp mounting post 2231 is fixedly connected to the lamp housing 2224, and the other end of the lamp mounting post 2231 is fixedly connected to a body component of the motorcycle 100 such as being detachably connected to license plate components 129 (such as to a license plate support bracket (not separately called out) through bolts (not shown). The circuit board 2225 is electrically connected to the battery 201 through a wiring harness (not shown) which is substantially positioned inside the lamp mounting post 2231.

When motorcycle 100 is running in normal driving condition, the center lighting area 2221 is preferably in a constantly lit state, stably emitting a running light signal to the rear of motorcycle 100. When the driver brakes the motorcycle 100, the brightness of the center lighting area 2221 increases, so as to emit a braking light signal to the rear of motorcycle 100. When the driver energizes a left or right turn signal on the motorcycle 100, the outer lighting area 2222 of the corresponding left or right taillight 222 flashes (blinks). In some embodiments, the left or right turn signal may be automatically turned on by rotation of the steering assembly 21. In some embodiments, the left or right turn signal may be automatically turned on by a sensed change in lean angle of the motorcycle 100, alone or in combination with rotation of the steering assembly 21. This preferred taillight 222 thus achieves integration of two light signal areas, transmitting at least three types of signals, through a single lamp assembly. In addition to effectively saving costs, this design can also effectively integrate multiple components on the motorcycle 100, thereby enhancing layout compactness.

The above description only expresses several embodiments of the present invention, and while their descriptions are specific and detailed, but such details should not be understood as limiting the scope of patent protection. For technical personnel having ordinary skill in this field, several modifications and improvements can be made without departing from the concept of the invention which are within the scope of protection of this application. Therefore, the scope of protection of this invention should be based on the attached claims.

1. A motorcycle comprising:
a frame comprising a main frame having a plurality of main frame tubes extending longitudinally, a sub-frame positioned behind the main frame and extending longitudinally, and a middle frame positioned behind the main frame, the middle frame having at least one vertically-extending leg;
a prime mover assembly at least partially supported by the main frame;
a plurality of wheels comprising a front wheel and a rear wheel;
a vehicle cover at least partially covering the main frame;
a suspension system comprising a rear suspension assembly, with the rear wheel connected to the middle frame by the rear suspension assembly;
characterized in that the frame further comprises a tailframe positioned behind the sub-frame, wherein the main frame tubes are made of a first material, the at least one vertically-extending leg of the middle frame is made of a second material, and a majority of the tailframe is made of a third material, the first material having a higher elongation at break than the second material and third material, and the third material having a lower density than the first material and second material.

2. The motorcycle of claim 1, wherein the frame further comprises a bottom support at least partially positioned below the main frame, the bottom support comprising at least one bottom support tube formed of the first material, a front end of the bottom support being detachably connected to the main frame, and a rear end of the bottom support being detachably connected to the middle frame.

3. The motorcycle of claim 2, wherein the main frame further comprises at least one descending tube positioned below and fixedly connected to one of the main frame tubes so as to extend downwardly and rearwardly therefrom, and wherein the front end of the bottom support is detachably connected to a bottom end of the descending tube at a connection junction, wherein the connection junction comprises a bottom fitting secured to the descending tube and a front fitting secured to bottom support tube, wherein at least one of the bottom fitting and the front fitting are formed of a fourth material so as to have one or more different material properties than the first material, one or more different material properties than the second material and one or more different material properties than the third material.

4. The motorcycle of claim 3, wherein the fourth material has the same composition as the first material.

5. The motorcycle of claim 4, wherein the first material is tubing of alloy steel, the second material is cast stainless steel, and the third material is aluminum or an aluminum alloy.

6. The motorcycle of claim 1, wherein the middle frame comprises a right casting and a left casting joined to the right casting by a main crosstube, the right casting providing a right vertically-extending leg of the middle frame, the left casting providing a left vertically-extending leg of the middle frame, the right casting and the left casting both being formed of cast stainless steel, and wherein the rear suspension assembly comprises a single rear shock absorber pivotally connected to the middle frame.

7. The motorcycle of claim 1, wherein the tailframe comprises at least one tailframe plate formed of aluminum or an aluminum alloy, the tailframe plate being in the shape of an arc with its center substantially aligned with a rotation center of the rear wheel.

8. The motorcycle of claim 7, wherein the vehicle cover comprises a saddle assembly having a main seat for a driver and a secondary seat for a passenger, wherein the secondary seat is arranged on the tailframe.

9. The motorcycle of claim 7, wherein the vehicle cover comprises a saddle assembly having a main seat for a driver, wherein a seat height of the motorcycle is defined as a vertical distance between a saddle point of the main seat and a line connecting rotational axes of the front and rear wheels, wherein the motorcycle has a wheelbase measured between rotational axes of the front and rear wheel, and wherein a seat height ratio of the seat height to the wheelbase of the motorcycle is greater than or equal to 0.22 and less than or equal to 0.26.

10. The motorcycle of claim 7, wherein the vehicle cover comprises a rear mudguard assembly, wherein the rear mudguard assembly comprises an upper mudguard cover and a lower mudguard both made of metal, wherein the upper mudguard cover is positioned above the at least one tailframe plate, and the lower mudguard is positioned below the at least one tailframe plate.

11. The motorcycle of claim 10, wherein the at least one tailframe plate comprises a fixing flange with an abutment shoulder defined on a rear end of the fixing flange, a height of the abutment shoulder being substantially equal to a thickness of the upper mudguard cover, with a forward end of the upper mudguard cover abutting against the abutment shoulder.

12. The motorcycle of claim 1, wherein the tailframe comprises a right tailframe plate, a left tailframe plate and at least one transverse tailframe connection strap, the right tailframe plate being formed of aluminum or an aluminum alloy, the left tailframe plate being formed of aluminum or an aluminum alloy, each of the right and left tailframe plates extending substantially vertically and longitudinally parallel to a longitudinal midplane, such that a thickness direction of each of the tailframe plates is in a transverse direction, the at least one transverse tailframe connection strap running between the right tailframe plate and the left tailframe plate.

13. The motorcycle of claim 1, wherein the sub-frame comprises a plurality of sub-frame tubes extending longitudinally, the plurality of sub-frame tubes being formed of the first material, wherein the sub-frame further comprises mid connection fittings welded to front ends of each of the plurality of sub-frame tubes, the mid connection fittings formed of a fourth material so as to have one or more different material properties than the first material, one or more different material properties than the second material and one or more different material properties than the third material, wherein the fourth material has the same composition as the first material.

14. The motorcycle of claim 1, further comprising a fuel tank and a tank adapter, the fuel tank being mounted at least partially above the main frame and at least partially above the sub-frame, the tank adapter including at least one tank contact point and at least one subframe contact point, with the at least one tank contact point and the at least one subframe contact point being separated by an adapter height distance so as to raise a rear end of the fuel tank relative to the sub-frame.

15. The motorcycle of claim 14, wherein the adapter height distance is greater than or equal to 80 mm and less than or equal to 100 mm.

16. The motorcycle of claim 1, wherein the sub-frame comprises at least one right sub-frame tube extending longitudinally and at least one left sub-frame tube extending longitudinally, wherein the vehicle cover comprises an internal cover at least partially disposed between the at least one right sub-frame tube and the at least one left sub-frame tube, wherein the motorcycle comprises an electronic controller and a battery disposed within an accommodating space defined by the internal cover.

17. The motorcycle of claim 1, wherein the main frame comprises a head tube fixed to front ends of the plurality of main frame tubes, wherein the main frame tubes comprise at least one right main frame tube and at least one left main frame tube, wherein the motorcycle comprises a steering lock arranged behind the head tube and between the left main frame tube and the right main frame tube.

18. A motorcycle comprising:
a frame comprising:
a main frame having a plurality of main frame tubes extending longitudinally, the plurality of main frame tubes being formed of steel,
a sub-frame positioned behind the main frame and extending longitudinally;
a middle frame positioned behind the main frame, the middle frame having at least one vertically-extending leg; and
a tailframe positioned behind the sub-frame, the tailframe comprising at least one tailframe plate formed of aluminum or an aluminum alloy, the tailframe plate being in the shape of an arc with its center substantially aligned with a rotation center of the rear wheel;
a prime mover assembly at least partially supported by the main frame;
a plurality of wheels comprising a front wheel and a rear wheel;
a vehicle cover at least partially covering the main frame; and
a suspension system comprising a rear suspension assembly, with the rear wheel connected to the middle frame by the rear suspension assembly.

19. The motorcycle of claim 18, wherein the at least one tailframe plate comprises a right tailframe plate formed of aluminum or an aluminum alloy and a left tailframe plate being formed of aluminum or an aluminum alloy, wherein the tailframe further comprises at least one transverse tailframe connection strap, each of the right and left tailframe plates extending substantially vertically and longitudinally parallel to a longitudinal midplane, such that a thickness direction of each of the tailframe plates is in a transverse direction, the at least one transverse tailframe connection strap running between the right tailframe plate and the left tailframe plate.

20. A motorcycle comprising:
a frame comprising:
a main frame having a plurality of main frame tubes extending longitudinally, the plurality of main frame tubes being formed of steel,
a sub-frame having a plurality of sub-frame tubes extending longitudinally, the plurality of sub-frame tubes being formed of steel, the sub-frame being detachably connected behind the main frame;
a middle frame positioned behind the main frame, the middle frame having at least one vertically-extending leg;
a bottom support positioned at least partially below the main frame, the bottom support comprising at least one bottom support tube formed of steel, the bottom support being detachably connected to the main frame and detachably connected to the middle frame; and
a tailframe detachably connected behind the sub-frame, the tailframe comprising at least one tailframe plate formed of aluminum or an aluminum alloy, the tailframe plate extending substantially vertically and longitudinally such that a thickness direction of the at least one tailframe plate is in a transverse direction;
a prime mover assembly at least partially supported by the main frame;
a plurality of wheels comprising a front wheel and a rear wheel, with the rear wheel positioned below the tailframe;
a vehicle cover at least partially covering the main frame; and
a suspension system comprising a rear suspension assembly, with the rear wheel connected to the middle frame by the rear suspension assembly.
